(19) United States
(12) Patent Application Publication
(10) Pub. No.: US 2015/0343886 A1
(43) Pub. Date: Dec. 3, 2015

(54) Vehicle Window Screen Device

(71) Applicant: Nancy L. Karns, Meadville, PA (US)

(72) Inventor: Nancy L. Karns, Meadville, PA (US)

(21) Appl. No.: 14/293,769

(22) Filed: Jun. 2, 2014

(51) Int. Cl. B60J 1/08; E06B 9/52

(52) U.S. Cl. CPC B60J 1/085; E06B 9/521

(57) ABSTRACT

A vehicle window screen device prevents bugs from entering a vehicle while a window of the vehicle is open. The device includes a screen having an outer perimeter and an open section. A door is coupled to the screen within the outer perimeter covering the open section. The door is pivotable between a closed position and an open position. A frame is coupled to the screen extending around the outer perimeter of the screen. Each of a plurality of fasteners is coupled to the frame wherein the frame is configured for coupling to a vehicle such that the screen covers a window opening of the vehicle.

### BACKGROUND OF THE DISCLOSURE

### Field of the Disclosure

The disclosure relates to window screen devices and more particularly pertains to a new window screen device for preventing bugs from entering a vehicle while a window of the vehicle is open.

### SUMMARY OF THE DISCLOSURE

An embodiment of the disclosure meets the needs presented above by generally comprising a screen having an outer perimeter and an open section. A door is coupled to the screen within the outer perimeter covering the open section. The door is pivotable between a closed position and an open position. A frame is coupled to the screen extending around the outer perimeter of the screen. Each of a plurality of fasteners is coupled to the frame wherein the frame is configured for coupling to a vehicle such that the screen covers a window opening of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a vehicle window screen device according to an embodiment of the disclosure.

FIG. 2 is a side view of an embodiment of the disclosure.

FIG. 3 is a partial cross-sectional view of an embodiment of the disclosure taken along line 3-3 of FIG. 2.

FIG. 4 is a side view of an embodiment of the disclosure in use.

### DESCRIPTION OF THE PREFERRED EMBODIMENT

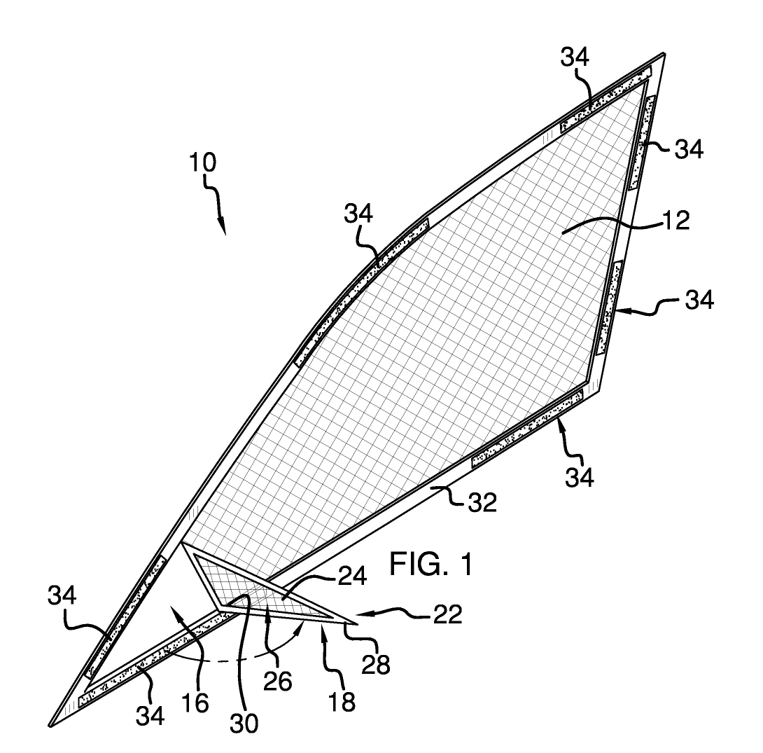

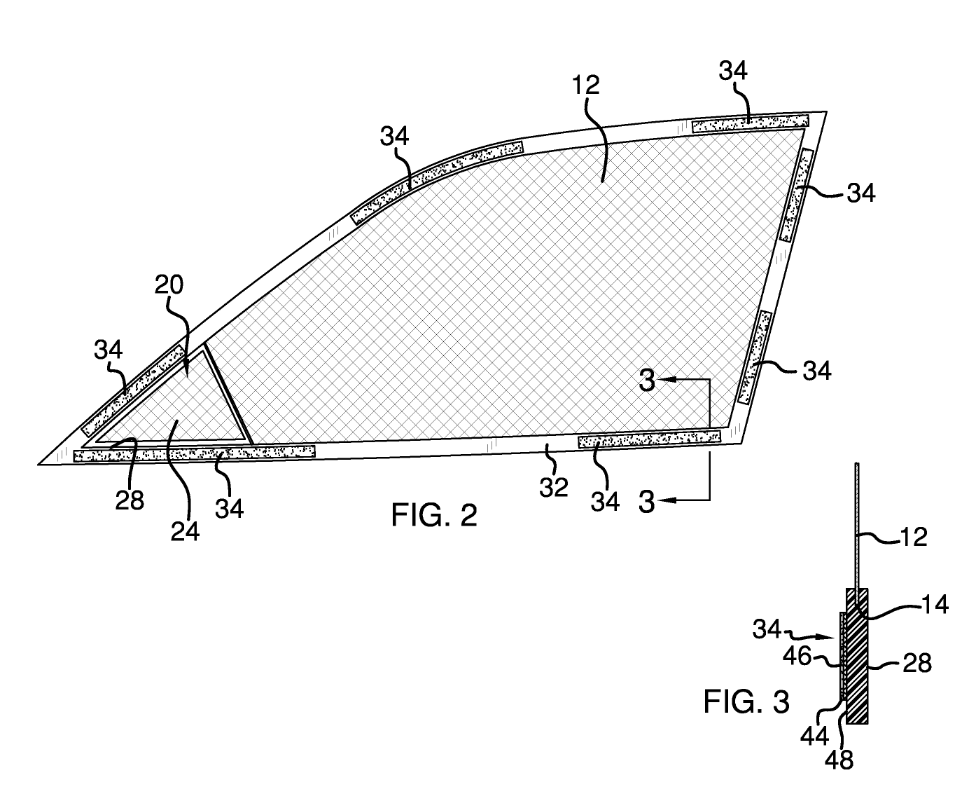

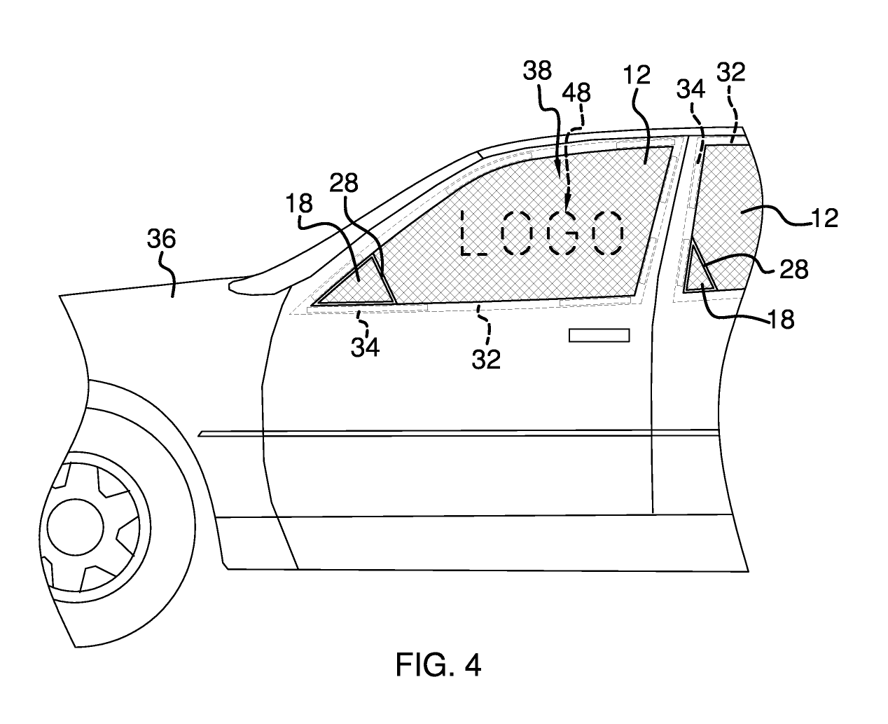

With reference now to the drawings, and in particular to FIGS. 1 through 4 thereof, a new window screen device embodying the principles and concepts of an embodiment of the disclosure and generally designated by the reference numeral 10 will be described.

As best illustrated in FIGS. 1 through 4, the vehicle window screen device 10 generally comprises a screen 12 having an outer perimeter 14. The screen 12 has an open section 16 allowing a person to extend a hand through the open section 16 of the screen 12. A door 18 is coupled to the screen 12 within the outer perimeter 14 and selectively covering the open section 16. The door 18 is pivotable between a closed position 20 and an open position 22. The door 18 has a triangular perimeter shape. An interior section 24 of the door 18 is mesh 26. The mesh 26 may be consistent with the material forming the screen 12. A border 28 is coupled to and extends around a peripheral edge 30 of the door 18. The border 28 is stiff relative to the door 18 and the screen 12 facilitating opening and closing of the door 18.

A frame 32 is coupled to the screen 12. The frame 32 extends around the outer perimeter 14 of the screen 12. The frame 32 is reinforced and stiff relative to the screen 12. The outer perimeter 14 of the screen 12 is embedded in the frame 32. Each of a plurality of fasteners 34 is coupled to the frame 32 wherein the frame 32 is configured for coupling to a vehicle 36 such that the screen 12 covers a window opening 38 of the vehicle 36. Each of the fasteners 34 is a portion of hook and loop fastener 40 having complementary and separable layers 44,46. Layer 44 is coupled directly to a surface 48 of the frame 32. Layer 46 is couplable to a surface 50 of the vehicle 36 such that coupling said complementary layers 44,46 together couples the screen 12 to the vehicle 36 covering the window opening 38. The screen 12 and frame 32 may be sized and shaped to correspond to the various shapes of window openings 38 for various vehicles 36. The fasteners 34 are spaced around the frame 32 to provide a sufficient connection between the frame 32 and the vehicle 36 to prevent unwanted flapping of the screen 12 or frame 32 on the vehicle 36 during use. Indicia 48 of a desired shape, pattern or logo may be positioned on the screen 12 wherein the indicia 48 is visible in the window opening 38 when the screen 12 is coupled to the vehicle 36.

In use, the screen 12 is positioned on the vehicle 36 to cover the window opening 38. The window of the vehicle 38 may then be opened while the vehicle 36 is used permitting fresh air to pass through the window opening 38. The screen 12 prevents bugs and debris from entering the vehicle 36 through the window opening 38. The door 18 may be opened as needed to facilitate passing or moving objects through the window opening 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle window screen device comprising:
a screen having an outer perimeter, said screen having an open section;
a door coupled to said screen within said outer perimeter covering said open section, said door being pivotable between a closed position and an open position;
a frame coupled to said screen, said frame extending around said outer perimeter of said screen; and
a plurality of fasteners coupled to said frame wherein said frame is configured for coupling to a vehicle such that said screen covers a window opening of the vehicle.

2. The device of claim 1, further comprising each of said fasteners being a portion of hook and loop fastener.

3. The device of claim 1, further comprising said door having a triangular perimeter shape.

4. The device of claim 1, further comprising said outer perimeter of said screen being embedded in said frame.

5. The device of claim 1, further comprising an interior section of said door being mesh.

6. The device of claim 5, further comprising a stiff border coupled to and extending around a peripheral edge of said door.

7. The device of claim 1, further comprising indicia being positioned on said screen wherein said indicia is visible in the window opening when said screen is coupled to the vehicle.

8. A vehicle window screen device comprising:
a screen having an outer perimeter, said screen having an open section;
a door coupled to said screen within said outer perimeter covering said open section, said door being pivotable between a closed position and an open position, said door having a triangular perimeter shape, an interior section of said door being mesh, a border being coupled to and extending around a peripheral edge of said door, said border being stiff;
a frame coupled to said screen, said frame extending around said outer perimeter of said screen, said outer perimeter of said screen being embedded in said frame;
a plurality of fasteners coupled to said frame wherein said frame is configured for coupling to a vehicle such that said screen covers a window opening of the vehicle, each of said fasteners being a portion of hook and loop fastener; and
indicia being positioned on said screen wherein said indicia is visible in the window opening when said screen is coupled to the vehicle.
